(19) United States
(12) Patent Application Publication
(10) Pub. No.: US 2011/0007504 A1
(43) Pub. Date: Jan. 13, 2011

(54) Self-Feedback Illuminating Equipment

(76) Inventor: Yu-Lin Chu, Tainan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/498,503

(22) Filed: Jul. 7, 2009

(51) Int. Cl. F21V 33/00

(52) U.S. Cl. 362/234; 362/253

(57) ABSTRACT

A self-feedback illuminating equipment includes a lighting source (1) and a self-feedback power supply device (2). The lighting source includes a light emitting unit (13). The self-feedback power supply device includes a plurality of collecting and transforming boards (21), a integrator (22), an electric storage unit (23), a converter unit (24), a first current adapter (242), and a second current adapter (243). Thus, the collecting and transforming boards can receive an optical energy from the light emitting unit and transform the optical energy into an electrical energy which is stored in the electric storage unit and is then supplied into the light emitting unit so as to save the electrical energy.

### BACKGROUND OF THE INVENTION

1. Field of the Invention

The present invention relates to a lamp and, more particularly, to an illuminating equipment to provide an illuminating effect.

2. Description of the Related Art

A conventional lamp comprises a lamp shade and a light emitting unit mounted in and surrounded by the lamp shade. Thus, the light emitting unit emits light beams or rays outwardly from the lamp shade so as to provide an illuminating effect. However, the conventional lamp cannot efficiently save the electrical energy. In addition, when some light beams of the light emitting unit are directed toward the lamp shade, the light beams are reflected by the lamp shade, so that the reflected light beams are directed toward a user in irregular directions, thereby easily damaging or hurting the user's eyes.

### BRIEF SUMMARY OF THE INVENTION

The primary objective of the present invention is to provide a self-feedback illuminating equipment that stores and provides an electrical energy by itself so as to provide a self-feedback power supply effect.

Another objective of the present invention is to provide an illuminating equipment, wherein the collecting and transforming boards receive an optical energy from the light emitting unit and transform the optical energy into an electrical energy which is stored in the electric storage unit and is then supplied into the light emitting unit so as to save the external electric power from the external power supply device and to decrease the cost of the electrical consumption.

A further objective of the present invention is to provide an illuminating equipment, wherein the light beams of the light emitting unit directed toward the lamp shade are absorbed by the collecting and transforming boards so that the lamp shade can reduce the reflected light of the light emitting unit so as to prevent the reflected light of the light emitting unit from damaging or hurting a user's eyes.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front cross-sectional view of an illuminating equipment in accordance with the preferred embodiment of the present invention.

FIG. 2 is a circuit layout of the illuminating equipment as shown in FIG. 1.

FIG. 3 is a circuit layout of the illuminating equipment as shown in FIG. 1.

FIG. 4 is a circuit layout of the illuminating equipment as shown in FIG. 1.

FIG. 5 is a schematic operational view of the illuminating equipment as shown in FIG. 1 in use.

FIG. 6 is a perspective view of the illuminating equipment as shown in FIG. 1.

FIG. 7 is a perspective view of an illuminating equipment in accordance with another preferred embodiment of the present invention.

FIG. 8 is a perspective view of an illuminating equipment in accordance with another preferred embodiment of the present invention.

FIG. 9 is a front cross-sectional view of an illuminating equipment in accordance with another preferred embodiment of the present invention.

### DETAILED DESCRIPTION OF THE INVENTION

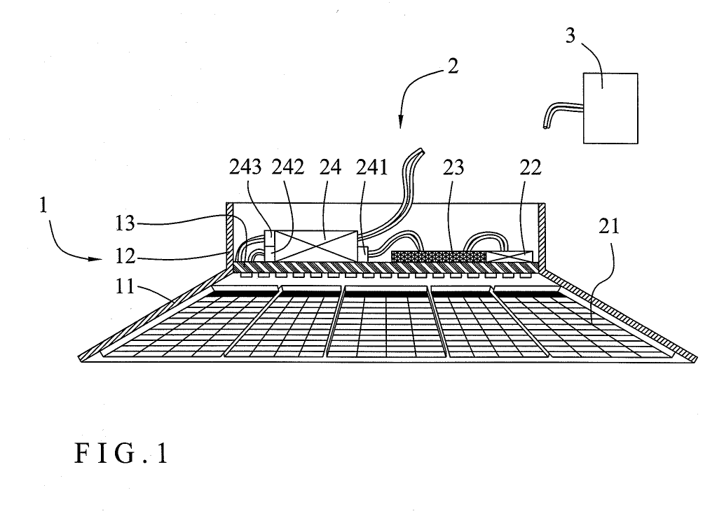

Referring to the drawings and initially to FIGS. 1-5, a self-feedback illuminating equipment in accordance with the preferred embodiment of the present invention comprises a lighting source 1 and a self-feedback power supply device 2.

The lighting source 1 includes a light emitting unit 13, a housing 12 to receive and support the light emitting unit 13, and a lamp shade 11 mounted on the housing 12 to cover the light emitting unit 13. The light emitting unit 13 of the lighting source 1 is mounted on the housing 12 and surrounded by the lamp shade 11.

The self-feedback power supply device 2 includes a plurality of collecting and transforming boards 21 surrounding the light emitting unit 13 of the lighting source 1, a integrator 22 electrically connected with the collecting and transforming boards 21, an electric storage unit 23 electrically connected with the integrator 22, a converter unit 24 electrically connected with the electric storage unit 23 and an external power supply device 3, a first current adapter 242 electrically connected between the converter unit 24 and the light emitting unit 13 of the lighting source 1, and a second current adapter 243 electrically connected between the converter unit 24 and the light emitting unit 13 of the lighting source 1.

The collecting and transforming boards 21 of the self-feedback power supply device 2 are mounted in an inner portion of the lamp shade 11 of the lighting source 1 and extend through a whole circumferential length of the lamp shade 11. The collecting and transforming boards 21 of the self-feedback power supply device 2 are juxtaposed to each other and abut an inner wall of the lamp shade 11 of the lighting source 1. The collecting and transforming boards 21 of the self-feedback power supply device 2 receive an optical energy from the light emitting unit 13 of the lighting source 1 and transform the optical energy into an electrical energy. The integrator 22, the electric storage unit 23, the converter unit 24, the first current adapter 242 and the second current adapter 243 of the self-feedback power supply device 2 are mounted in the housing 12 of the lighting source 1.

The converter unit 24 of the self-feedback power supply device 2 is provided with a detection switch 241 electrically connected with the electric storage unit 23 to detect the electric capacity of the electric storage unit 23. The first current adapter 242 of the self-feedback power supply device 2 is electrically connected with the electric storage unit 23 via the converter unit 24 and the detection switch 241 of the converter unit 24 to allow passage of a direct current of a power supply. The second current adapter 243 of the self-feedback power supply device 2 is electrically connected with the external power supply device 3 via the converter unit 24 to allow passage of an alternating current of a power supply.

In practice, the external power supply device 3 transmits an external electric power (or an alternating-current power supply) through the converter unit 24 to the second current adapter 243. The second current adapter 243 of the self-feedback power supply device 2 then transmits the external electric power (or the alternating-current power supply) to the light emitting unit 13 of the lighting source 1.

Alternatively, the integrator 22 of the self-feedback power supply device 2 receives the electrical energy from the collecting and transforming boards 21 and then integrates the electrical energy into a stabilized electrical energy. Then, the integrator 22 of the self-feedback power supply device 2 transmits the integrated electrical energy to the electric storage unit 23 which stores the electrical energy. Then, when the detection switch 241 of the converter unit 24 detects that the electrical energy contained in the electric storage unit 23 is disposed at a saturated state, the electric storage unit 23 of the self-feedback power supply device 2 transmits the electrical energy (or the direct-current power supply) through the detection switch 241 and the converter unit 24 to the first current adapter 242. Then, the first current adapter 242 of the self-feedback power supply device 2 transmits the electrical energy (or the direct-current power supply) to the light emitting unit 13 of the lighting source 1.

In such a manner, the alternating-current power supply from the external power supply device 3 is delivered through the converter unit 24 and the second current adapter 243 of the self-feedback power supply device 2 into the light emitting unit 13 of the lighting source 1, and the direct-current power supply from the electric storage unit 23 of the self-feedback power supply device 2 is delivered through the converter unit 24 and the first current adapter 242 of the self-feedback power supply device 2 into the light emitting unit 13 of the lighting source 1, so that the alternating-current power supply from the external power supply device 3 and the direct-current power supply from the electric storage unit 23 of the self-feedback power supply device 2 are supplied alternately into the light emitting unit 13 of the lighting source 1 according to the practical requirement.

In addition, the alternating current from the external power supply device 3 passes through the converter unit 24 and the second current adapter 243 into the light emitting unit 13 of the lighting source 1, and the direct current from the electric storage unit 23 of the self-feedback power supply device 2 passes through the converter unit 24 and the first current adapter 242 into the light emitting unit 13 of the lighting source 1 respectively, so that the converter unit 24 can efficiently separate the alternating current of the external power supply device 3 from the direct current of the electric storage unit 23 of the self-feedback power supply device 2 to prevent the alternating current of the external power supply device 3 and the direct current of the electric storage unit 23 of the self-feedback power supply device 2 from interfering with each other.

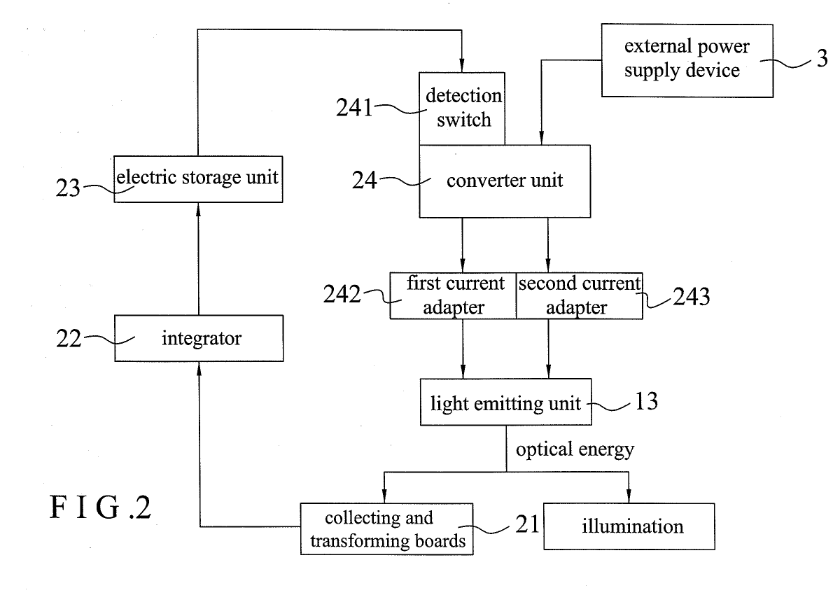

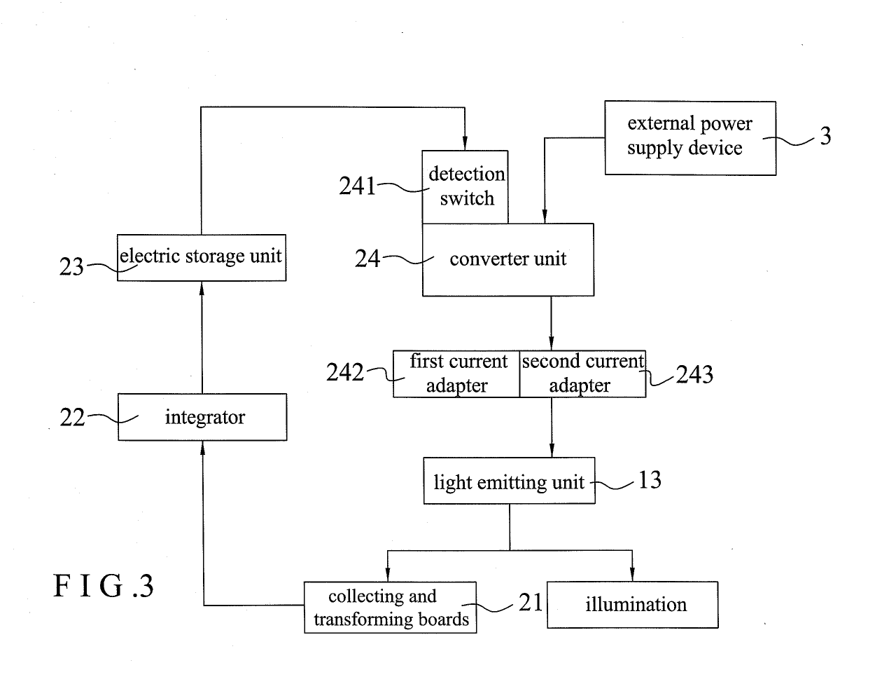

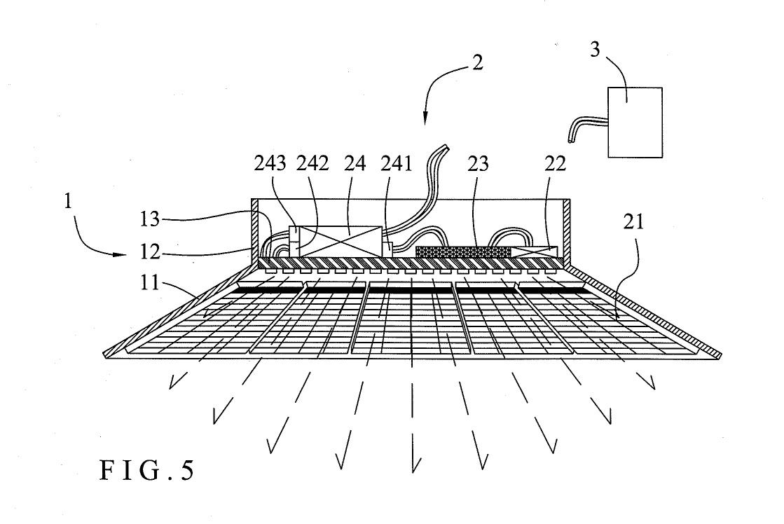

In operation, referring to FIGS. 3-5 with reference to FIGS. 1 and 2, the external power supply device 3 is electrically connected with the second current adapter 243 through the converter unit 24. Thus, the external electric power (or alternating-current power supply) from the external power supply device 3 is supplied through the second current adapter 243 into the light emitting unit 13 of the lighting source 1 at a normal state as shown in FIG. 3 so that the light emitting unit 13 of the lighting source 1 is energized to emit light beams outward as shown in FIG. 5 so as to provide an illuminating effect.

At this time, when the light beams from the light emitting unit 13 of the lighting source 1 are projected onto the lamp shade 11 of the lighting source 1, the collecting and transforming boards 21 of the self-feedback power supply device 2 receive the optical energy from the light emitting unit 13 of the lighting source 1 and transform the optical energy into an electrical energy. Then, the integrator 22 of the self-feedback power supply device 2 receives and integrates the electrical energy from the collecting and transforming boards 21 and transmits the integrated electrical energy to the electric storage unit 23 successively.

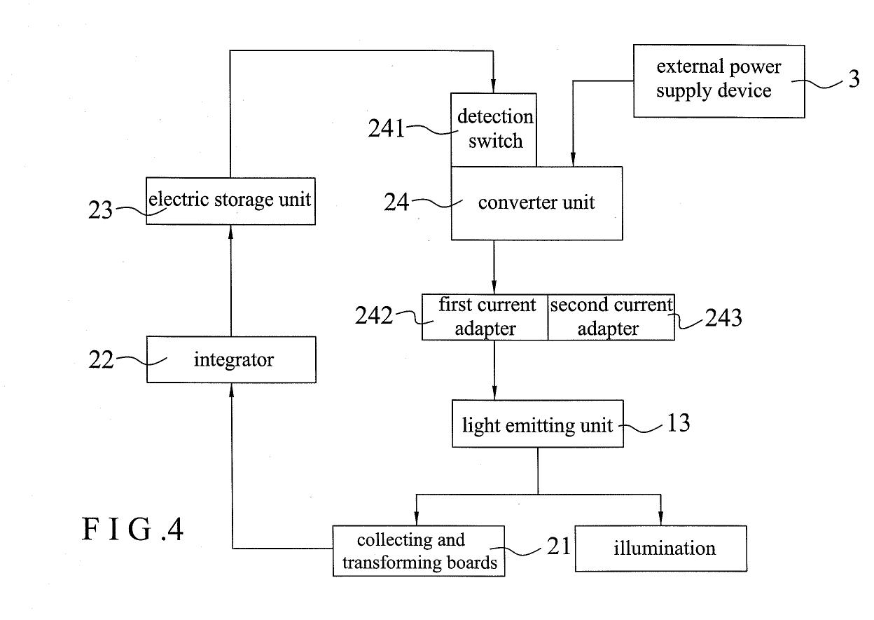

When the detection switch 241 of the converter unit 24 detects that the electrical energy contained in the electric storage unit 23 is disposed at a saturated state, the converter unit 24 interrupts the electrical connection between the external power supply device 3 and the second current adapter 243 and opens the electrical connection between the electric storage unit 23 and the first current adapter 242 so that the electric storage unit 23 is electrically connected with the first current adapter 242 through the converter unit 24 as shown in FIG. 4. Thus, the electrical energy (or direct-current power supply) from the electric storage unit 23 is supplied through the first current adapter 242 into the light emitting unit 13 of the lighting source 1 so as to light the light emitting unit 13 of the lighting source 1 successively.

On the contrary, when the detection switch 241 of the converter unit 24 detects that the electrical energy contained in the electric storage unit 23 is exhausted, the converter unit 24 interrupts the electrical connection between the electric storage unit 23 and the first current adapter 242 and opens the electrical connection between the external power supply device 3 and the second current adapter 243 so that the external power supply device 3 is electrically connected with the second current adapter 243 through the converter unit 24. Thus, the external electric power (or alternating-current power supply) from the external power supply device 3 is again supplied through the second current adapter 243 into the light emitting unit 13 of the lighting source 1 so as to light the light emitting unit 13 of the lighting source 1 successively.

Accordingly, the collecting and transforming boards 21 receive an optical energy from the light emitting unit 13 and transform the optical energy into an electrical energy which is stored in the electric storage unit 23 and is then supplied into the light emitting unit 13 so as to save the external electric power from the external power supply device 3 and to decrease the cost of the electrical consumption. In addition, the light beams of the light emitting unit 13 directed toward the lamp shade 11 are absorbed by the collecting and transforming boards 21 so that the lamp shade 11 can reduce the reflected light of the light emitting unit 13 so as to prevent the reflected light of the light emitting unit 13 from damaging or hurting a user's eyes.

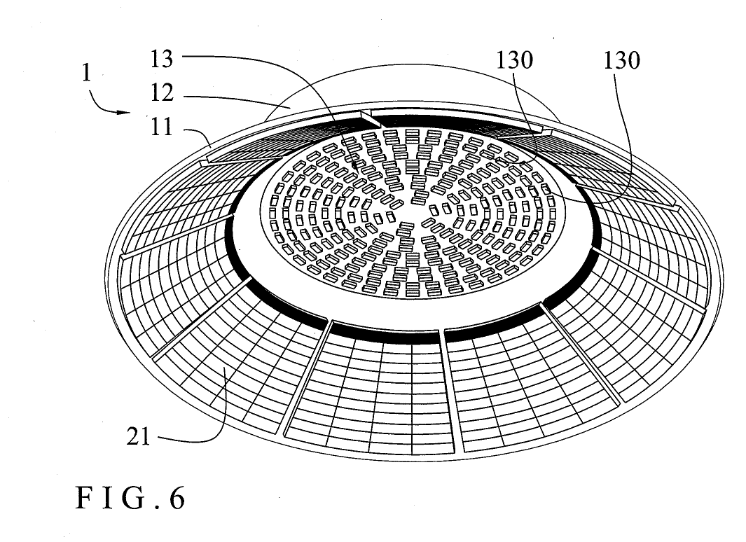

As shown in FIG. 6, the light emitting unit 13 of the lighting source 1 includes a plurality of light emitting diodes (LEDs) 130.

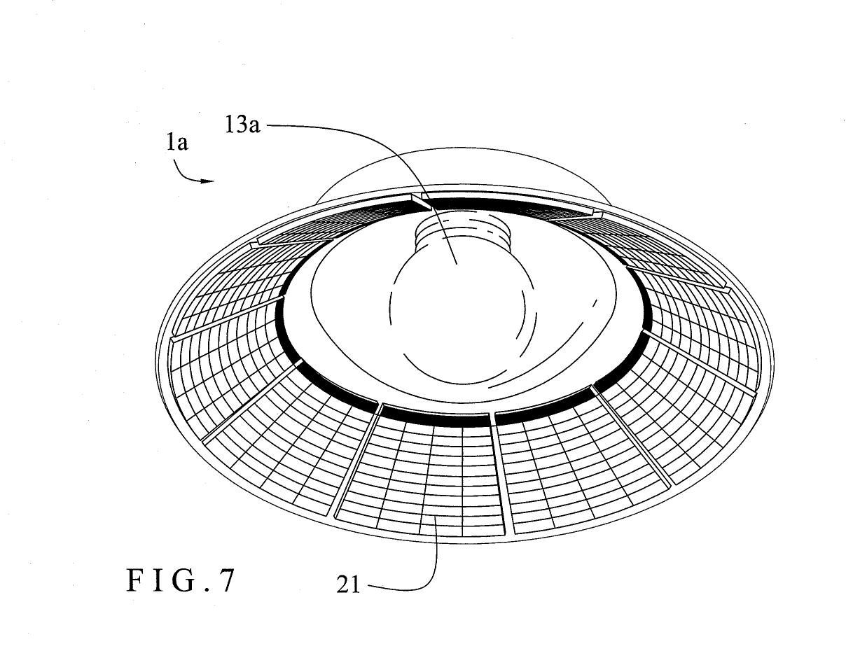

As shown in FIG. 7, the light emitting unit 13a of the lighting source 1a is an incandescent bulb.

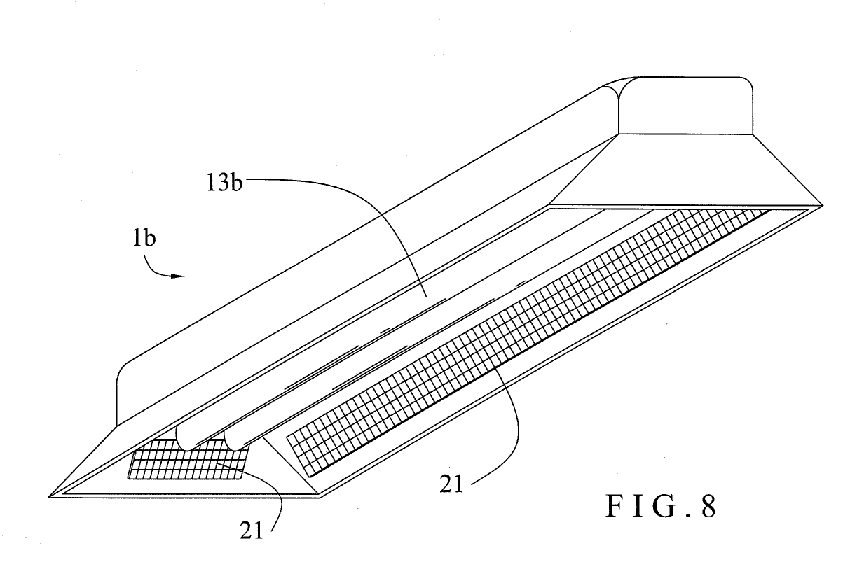

As shown in FIG. 8, the light emitting unit 13b of the lighting source 1b is a fluorescent tube.

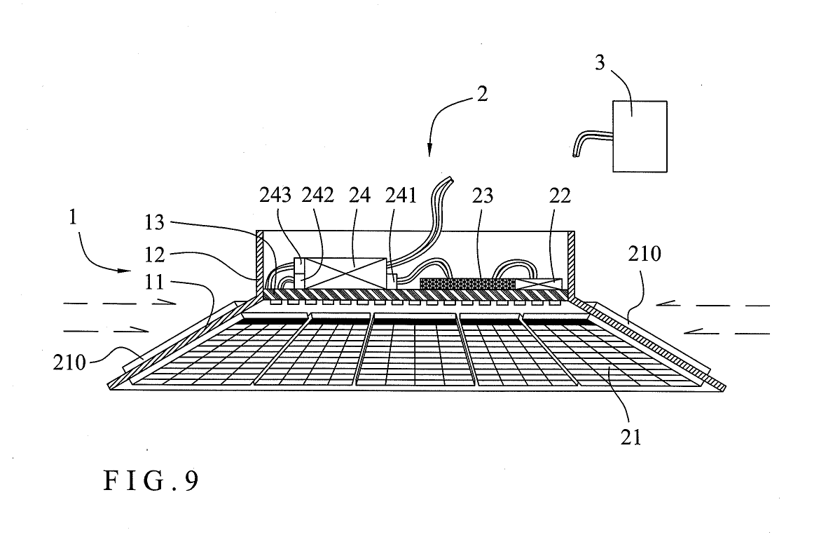

As shown in FIG. 9, the self-feedback power supply device 2 further includes a plurality of secondary collecting and transforming boards 210 surrounding the light emitting unit 13 of the lighting source 1 and electrically connected with the integrator 22. The secondary collecting and transforming boards 210 of the self-feedback power supply device 2 are mounted on an outer portion of the lamp shade 11 of the lighting source 1 and extend through a whole circumferential length of the lamp shade 11. The secondary collecting and transforming boards 210 of the self-feedback power supply device 2 receive an optical energy from the ambient environment and transform the optical energy into an electrical energy which is stored in the electric storage unit 23 and is then supplied into the light emitting unit 13.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An illuminating equipment, comprising a lighting source (1) and a self-feedback power supply device (2), wherein:
the lighting source includes:
a light emitting unit (13);
the self-feedback power supply device includes:
a plurality of collecting and transforming boards (21) surrounding the light emitting unit of the lighting source;
a integrator (22) electrically connected with the collecting and transforming boards;
an electric storage unit (23) electrically connected with the integrator;
a converter unit (24) electrically connected with the electric storage unit and an external power supply device (3);
a first current adapter (242) electrically connected between the converter unit and the light emitting unit of the lighting source; and
a second current adapter (243) electrically connected between the converter unit and the light emitting unit of the lighting source.

2. The illuminating equipment of claim 1, wherein the lighting source further includes:
a housing (12) to receive and support the light emitting unit; and
a lamp shade (11) mounted on the housing to cover the light emitting unit.

3. The illuminating equipment of claim 2, wherein the collecting and transforming boards of the self-feedback power supply device are mounted in an inner portion of the lamp shade of the lighting source.

4. The illuminating equipment of claim 2, wherein the converter unit of the self-feedback power supply device is provided with a detection switch (241) electrically connected with the electric storage unit.

5. The illuminating equipment of claim 2, wherein the integrator, the electric storage unit, the converter unit, the first current adapter and the second current adapter of the self-feedback power supply device are mounted in the housing of the lighting source.

6. The illuminating equipment of claim 1, wherein the first current adapter of the self-feedback power supply device is electrically connected with the electric storage unit via the converter unit and the detection switch of the converter unit.

7. The illuminating equipment of claim 1, wherein the second current adapter of the self-feedback power supply device is electrically connected with the external power supply device via the converter unit.

8. The illuminating equipment of claim 1, wherein the light emitting unit of the lighting source includes a plurality of light emitting diodes (130).

9. The illuminating equipment of claim 1, wherein the light emitting unit of the lighting source is an incandescent bulb.

10. The illuminating equipment of claim 1, wherein the light emitting unit of the lighting source is a fluorescent tube.

11. The illuminating equipment of claim 2, wherein the collecting and transforming boards of the self-feedback power supply device extend through a whole circumferential length of the lamp shade.

12. The illuminating equipment of claim 2, wherein the collecting and transforming boards of the self-feedback power supply device are juxtaposed to each other and abut an inner wall of the lamp shade of the lighting source.

13. The illuminating equipment of claim 2, wherein the self-feedback power supply device further includes:
a plurality of secondary collecting and transforming boards (210) surrounding the light emitting unit of the lighting source and electrically connected with the integrator.

14. The illuminating equipment of claim 13, wherein the secondary collecting and transforming boards of the self-feedback power supply device are mounted on an outer portion of the lamp shade of the lighting source.

15. The illuminating equipment of claim 13, wherein the secondary collecting and transforming boards of the self-feedback power supply device extend through a whole circumferential length of the lamp shade.

16. The illuminating equipment of claim 1, wherein the light emitting unit of the lighting source is mounted on the housing and surrounded by the lamp shade.

17. The illuminating equipment of claim 1, wherein
the collecting and transforming boards of the self-feedback power supply device receive an optical energy from the light emitting unit of the lighting source and transform the optical energy into an electrical energy;
the integrator of the self-feedback power supply device receives and integrates the electrical energy from the collecting and transforming boards and transmits the electrical energy to the electric storage unit;
the electric storage unit of the self-feedback power supply device transmits the electrical energy through the converter unit to the first current adapter;
the first current adapter of the self-feedback power supply device transmits the electrical energy to the light emitting unit of the lighting source.

18. The illuminating equipment of claim 17, wherein
the external power supply device transmits an external electric power through the converter unit to the second current adapter;
the second current adapter of the self-feedback power supply device transmits the external electric power to the light emitting unit of the lighting source.
